(19) United States
(12) Patent Application Publication
(10) Pub. No.: US 2009/0225099 A1
(43) Pub. Date: Sep. 10, 2009

(54) IMAGE PROCESSING APPARATUS AND METHOD

(75) Inventor: Mayumi YUASA, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/397,609

(22) Filed: Mar. 4, 2009

(30) Foreign Application Priority Data
Mar. 5, 2008 (JP) 2008-055025

(51) Int. Cl. G09G 5/00

(52) U.S. Cl. 345/629; 382/201; 382/154

(57) ABSTRACT

A storage unit stores three-dimensional shape information of a model for an object included in a first image. The information includes three-dimensional coordinates of feature points of the model. A feature point detection unit detects feature points from the first image. A correspondence calculation unit calculates a first motion matrix representing a correspondence relationship between the object and the model from the feature points of the first image and the feature points of the model. A normalized image generation unit generates a normalized image of a second image by corresponding the second image with the information. A synthesized image generation unit corresponds each pixel of the first image with each pixel of the normalized image by using the first motion matrix, and generates a synthesized image by blending a region of the object of the first image with corresponding pixels of the normalized image.

### CROSS-REFERENCE TO RELATED APPLICATIONS

This application is based upon and claims the benefit of priority from Japanese Patent Application No. 2008-55025, filed on Mar. 5, 2008; the entire contents of which are incorporated herein by reference.

### FIELD OF THE INVENTION

The present invention relates to an apparatus and a method for generating a synthesized image by blending a plurality of images such as different facial images.

### BACKGROUND OF THE INVENTION

With regard to an image processing apparatus for synthesizing a facial image of the conventional technology, as shown in JP-A 2004-5265 (KOKAI), a morphing image is synthesized by corresponding coordinates of facial feature points among a plurality of different facial images. However, the facial feature points are corresponded on two-dimensional image. Accordingly, if facial directions of the plurality of facial images are different, a natural synthesized image cannot be generated.

As another conventional technology shown in JP-A 2002-232783 (KOKAI), a facial image in video is replaced with a three-dimensional facial model. In this case, the three-dimensional facial model to overlap with the facial image need be previously generated. However, the three-dimensional facial model cannot be generated from only one original image, and it takes a long time to generate the three-dimensional facial model.

Furthermore, as shown in JP No. 3984191, a facial direction of a facial image as an object is determined, and a drawing region to make up the facial image is changed according to the facial direction. However, a plurality of different facial images cannot be synthesized, and an angle of the facial direction need be explicitly calculated.

As mentioned-above, with regard to the first conventional technology, in case of synthesizing facial images having different facial directions, the natural synthesized image cannot be generated. With regard to the second conventional technology, the three-dimensional model of the object face need be previously created. Furthermore, with regard to the third conventional technology, the facial direction of the facial image need be explicitly calculated.

### SUMMARY OF THE INVENTION

The present invention is directed to an image processing apparatus and a method for naturally synthesizing a plurality of facial images having different facial directions by using a three-dimensional shape model.

According to an aspect of the present invention, there is provided an apparatus for processing an image, comprising: an image input unit configured to input a first image including an object; a storage unit configured to store a three-dimensional shape information of a model for the object, the three-dimensional shape information including three-dimensional coordinates of a plurality of feature points of the model; a feature point detection unit configured to detect a plurality of feature points from the first image; a correspondence calculation unit configured to calculate a first motion matrix representing a correspondence relationship between the object and the model from the plurality of feature points of the first image and the plurality of feature points of the model; a normalized image generation unit configured to generate a normalized image of a second image by corresponding the second image with the three-dimensional shape information; and a synthesized image generation unit configured to correspond each pixel of the first image with each pixel of the normalized image by using the first motion matrix, and generate a synthesized image by blending a region of the object of the first image with corresponding pixels of the normalized image.

### BRIEF DESCRIPTION OF THE DRAWINGS

FIG. 1 is a block diagram of the image processing apparatus according to the first embodiment.

FIG. 2 is a flow chart of operation of the image processing apparatus in FIG. 1.

FIG. 3 is a schematic diagram of exemplary facial feature points.

FIG. 4 is a schematic diagram of projection situation of facial feature points of three-dimensional shape information by a motion matrix M.

FIG. 5 is a schematic diagram of entire processing situation according to the first embodiment.

FIG. 6 is a flow chart of operation of the image processing apparatus according to the second embodiment.

FIG. 7 is a schematic diagram of entire processing situation according to the second embodiment.

FIG. 8 is a schematic diagram of exemplary cheek blush according to the third embodiment.

FIG. 9 is a schematic diagram of an exemplary partial mask according to the third modification.

### DETAILED DESCRIPTION OF THE EMBODIMENTS

Hereinafter, embodiments of the present invention will be explained by referring to the drawings. The present invention is not limited to the following embodiments.

### The First Embodiment

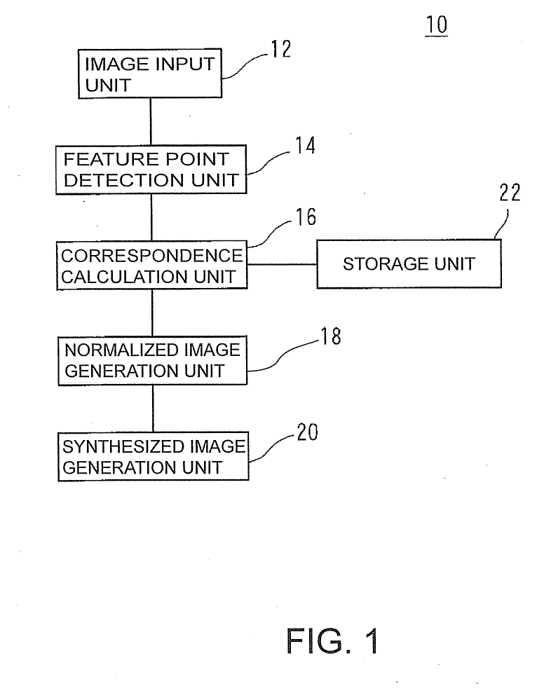

The image processing apparatus 10 of the first embodiment is explained by referring to FIGS. 1˜5. In the first embodiment, with regard to a face of person A in one still image, a face of person B in another still image is synthesized.

FIG. 1 is a block diagram of the image processing apparatus 10 of the first embodiment. The image processing apparatus includes an image input unit 12, a feature point detection unit 14, a correspondence calculation unit 16, a normalized image generation unit 18, a synthesized image generation unit 20, and a storage unit 22.

The image input unit 12 inputs a first image (including a face of person A) and a second image (including a face of person B). The feature point detection unit 14 detects a plurality of feature points from the first image and the second image. The storage unit 22 stores three-dimensional shape information representing a model as a general shape of object. The correspondence calculation unit 16 calculates correspondence relationship between the feature points (of the first image and the second image) and the three-dimensional shape information.

The normalized image generation unit 18 generates a normalized image of the second image by correspondence relationship between the feature points of the second image and the three-dimensional shape information. The synthesized image generation unit 20 corresponds pixels of the first image with pixels of the normalized image by the correspondence relationship with the three-dimensional shape information, and synthesizes the first image with the normalized image by corresponded pixels between the first image and the normalized image.

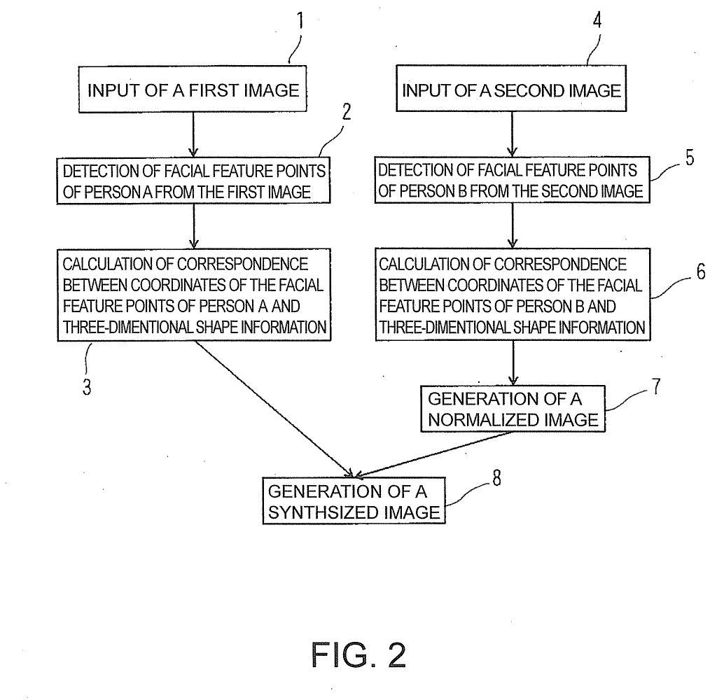

Next, operation of the image processing apparatus 10 is explained by referring to FIG. 2. FIG. 2 is a flow chart of operation of the image processing apparatus 10. First, the image input unit 12 inputs the first image including a face of person A (step 1 in FIG. 2). As to the input method, for example, the first image is input by a digital camera.

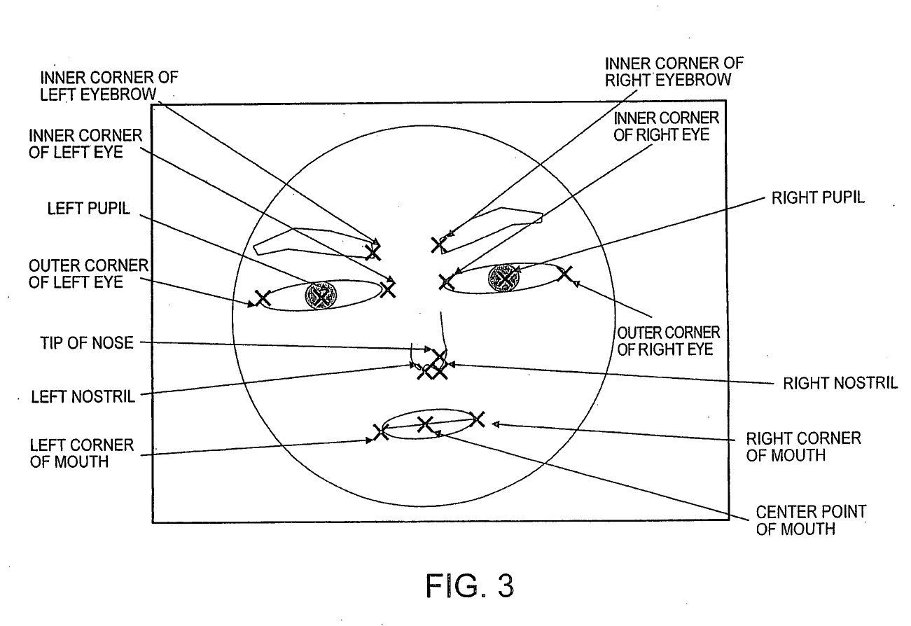

Next, the feature point detection unit 14 detects a plurality of facial feature points of person A from the first image as shown in FIG. 3 (step 2 in FIG. 2). For example, as shown in JP No. 3279913, a plurality of feature point candidates is detected using a separability filter, a group of feature points is selected from the plurality of feature point candidates by evaluating a locative combination of the feature point candidates, and the group of feature points is matched with a template of facial part region. As a type of the feature point, for example, fourteen points shown in FIG. 3 are used.

Next, the correspondence calculation unit 16 calculates a correspondence relationship between coordinates of the plurality of facial feature points (detected by the feature point detection unit 14) and coordinates of facial feature points in the three-dimensional shape information (stored in the storage unit 22) (step 3 in FIG. 2). Hereafter, this calculation method is explained. In this case, the storage unit 22 previously stores three-dimensional shape information of a generic face model. Furthermore, the three-dimensional shape information includes position information (three-dimensional coordinates) of facial feature points.

First, by using the factorization method disclosed in JP-A 2003-141552 (KOKAI), a motion matrix M representing a correspondence relationship between the first image and the model is calculated. Briefly, a shape matrix S which base positions of facial feature points on the three-dimensional shape information, and a measurement matrix W which base positions of facial feature points on the first image, are prepared. The motion matrix M is calculated from the shape matrix S and the measurement matrix W.

In case of projecting facial feature points of three-dimensional shape information onto the first image, the motion matrix M is regarded as a projection matrix to minimize an error between projected feature points and facial feature points on the first image. Based on this projection relationship, a coordinate (x,y) which a facial coordinate (X,Y,Z) of three-dimensional shape information is projected onto the first image is calculated by the motion matrix M with following equation (1). In this case, the coordinate is based on a position of center of gravity of the face.

(x,y)^{T}=M(X,Y,Z)^{T} (1)

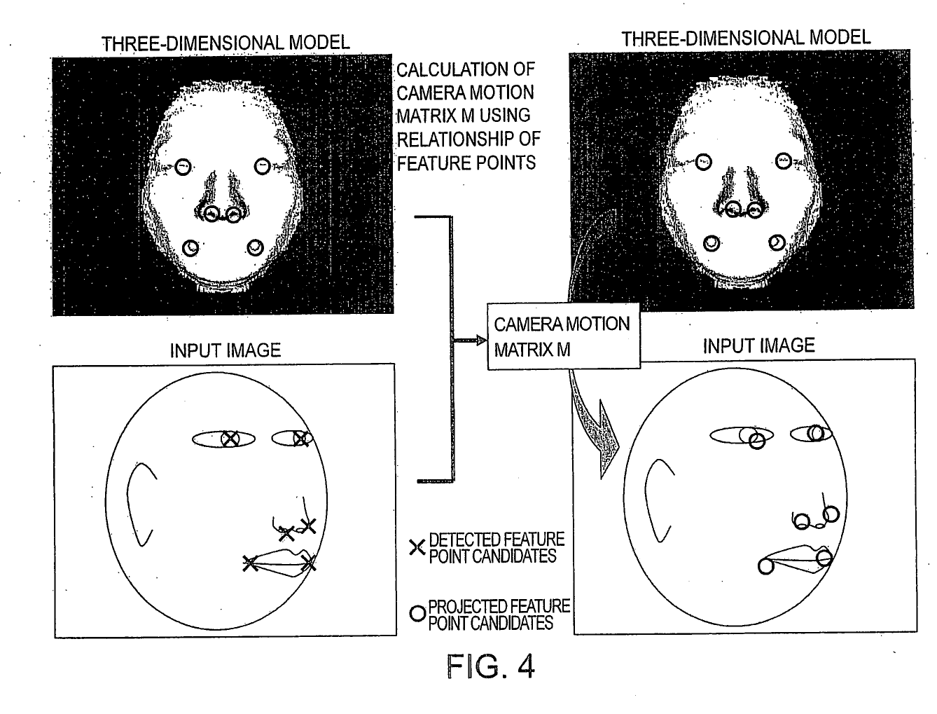

FIG. 4 is a schematic diagram of facial feature points of three-dimensional shape information projected by the motion matrix M. Hereafter, processing related to the second image is executed. Processing of the second image can be executed in parallel with the first image, or may be previously executed if the second image is fixed.

First, the image input unit 12 inputs the second image including a face of person B (step 4 in FIG. 2). In the same way as the first image, the second image may be taken by a digital camera, or previously stored in a memory. Next, the feature point detection unit 14 detects a plurality of facial feature points of the person B from the second image (step 5 in FIG. 2). The method for detecting feature points is same as that of the first image.

Next, the correspondence calculation unit 16 calculates a correspondence relationship between coordinates of facial feature points of the second image (detected by the feature point detection unit 14) and coordinates of facial feature points of the three-dimensional shape information (step 6 in FIG. 2). The method for calculating the correspondence relationship is same as that of the first image. As a result, a coordinate (x′,y′) which a facial coordinate (X,Y,Z) of three-dimensional shape information is projected onto the second image is calculated by the motion matrix M′ with following equation (2).

(x′,y′)^{T}=M′(X,Y,Z)^{T} (2)

Next, the normalized image generation unit 18 generates a normalized image of the second image by using a correspondence relationship of the equation (2) (step 7 in FIG. 2). A coordinate (s,t) on the normalized image is set as (X,Y). As to the coordinate (X,Y), Z-coordinate is determined by the three-dimensional shape information. By using the correspondence relationship of the equation (2), a coordinate (x′,y′) on the second image corresponding to (s,t) is calculated.

Accordingly, a pixel value “Iₙₒᵣₘ(s,t)=I′(x′,y′)” corresponding to (s,t) on the normalized image is obtained. By repeating this calculation for each pixel of a normalized image having a predetermined size, the normalized image can be generated. As a result, irrespective of a size and a facial direction of the second image, the normalized image having a predetermined size and a facial direction corresponding to the three-dimensional shape information can be obtained.

With regard to the synthesized image generation unit 20, by using the first image, the normalized image and the correspondence relationship of the equation (1), a synthesized image is generated by overlapping a facial part of person A of the first image with a facial part of person B of the second image (step 8 in FIG. 2). A method for generating the synthesized image is explained.

As mentioned-above, the normalized image is corresponded with the three-dimensional shape information. Accordingly, by the correspondence relationship of the equation (1), the first image can be corresponded with the normalized image. In order to generate the synthesized image, a pixel value Iₙₒᵣₘ(s,t) at (s,t) on the normalized image corresponding to (x,y) on the first image is necessary.

As to the correspondence relationship of the equation (1), in case of “s=X, t=Y”, a corresponding coordinate (x,y) on the first image is obtained. However, the coordinate (s,t) on the normalized image cannot be obtained from the coordinate (x,y) on the first image. Accordingly, by changing the coordinate (s,t) on the normalized image, (x(s,t), y(s,t)) on the first image corresponding to each pixel on the normalized image is previously calculated.

Next, as to (x,y) within an object region (facial region of person A) on the first image, (s,t) on the normalized image is determined on condition that “x=x(s,t), y=y(s,t)”. If corresponding (s,t) does not exist on the normalized image, a pixel value of another coordinate nearest (s,t) on the normalized image is selected, or the pixel value is interpolated from other pixels adjacent to (s,t) on the normalized image.

When (s,t) on the normalized image corresponding each (x,y) on the first image is obtained, a synthesized image is generated by following equation (3).

I_{blend}(x,y)=αI(x,y)+(1−α)Iₙₒᵣₘ(s,t) (3)

In the equation (3), I_{blend}(x,y) is a pixel value of the synthesized image, I(x,y) is a pixel value of the first image, Iₙₒᵣₘ(s,t) is a pixel value of the normalized image, and α is a blend ratio represented by following equation.

α=α_{blend}αₘₐₛₖ (4)

In the equation (4), α_{blend} is a value determined by a ratio that the first image and the second image are blended. For example, if the synthesized image is generated at a middle rate of the first image and the second image, α_{blend} is set as 0.5. Furthermore, if the first image is replaced with the second image, α_{blend} is set as 1.

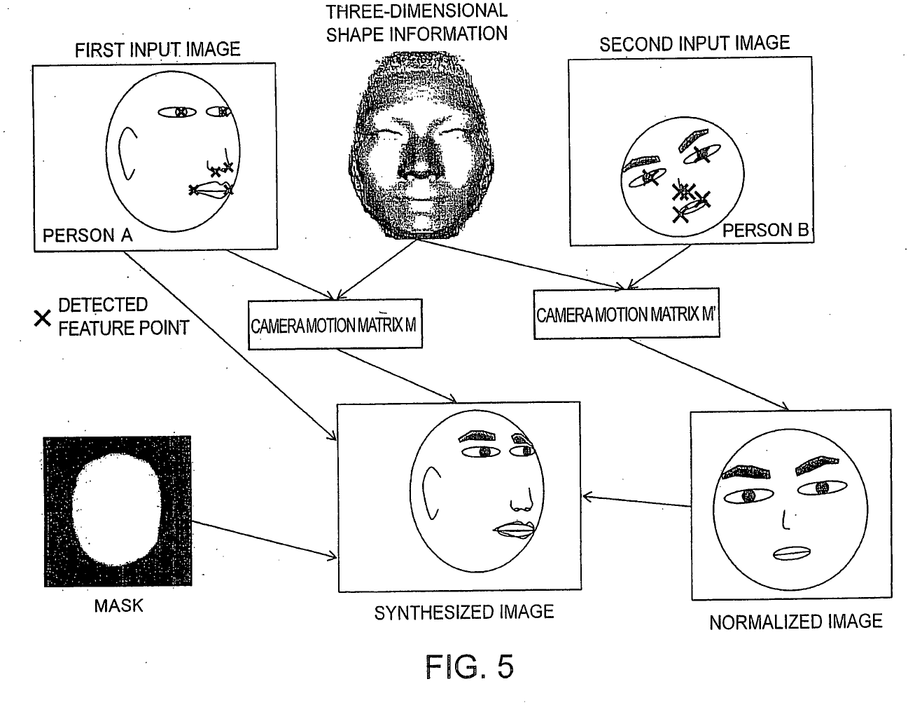

Furthermore, αₘₐₛₖ is a parameter to set a synthesis region, and determined by coordinate on the normalized image. If an inside region of face is the synthesis region, αₘₐₛₖ is 1. If an outside region of face is the synthesis region, αₘₐₛₖ is 0. A boundary of the synthesis region is an outline of face of the three-dimensional shape information. It is desirable that the boundary is set to smoothly change. For example, the boundary is shaded using the Gaussian function. In this case, the boundary of the synthesized image is naturally connected with the first image, and a natural synthesized image is generated. For example, as shown in FIG. 5, αₘₐₛₖ is prepared as a mask image having the same size as the normalized image.

In above explanation, the pixel has one numerical value. However, for example, the pixel may have three numerical values of RGB. In this case, the same processing is executed for each numerical value of RGB.

As mentioned-above, in the image processing apparatus of the first embodiment, by corresponding feature points with three-dimensional shape information, a plurality of object images having different facial directions can be naturally synthesized. This synthesized image has the same effect as a morphing image, and an intermediate facial image of two persons can be obtained. Furthermore, in comparison with the morphing image which a part between corresponded feature points on two images is interpolated, even if facial directions or facial sizes of two images are different, a natural synthesized image can be obtained.

### The Second Embodiment

The image processing apparatus 10 of the second embodiment is explained by referring to FIGS. 1, 6 and 7. Component of the image processing apparatus 10 of the second embodiment is same as the first embodiment. With regard to the second embodiment, faces of two persons are detected from an image input by a video camera (taking a dynamic image) and mutually replaced in the image. This blended image in which two face regions are replaced is generated and displayed.

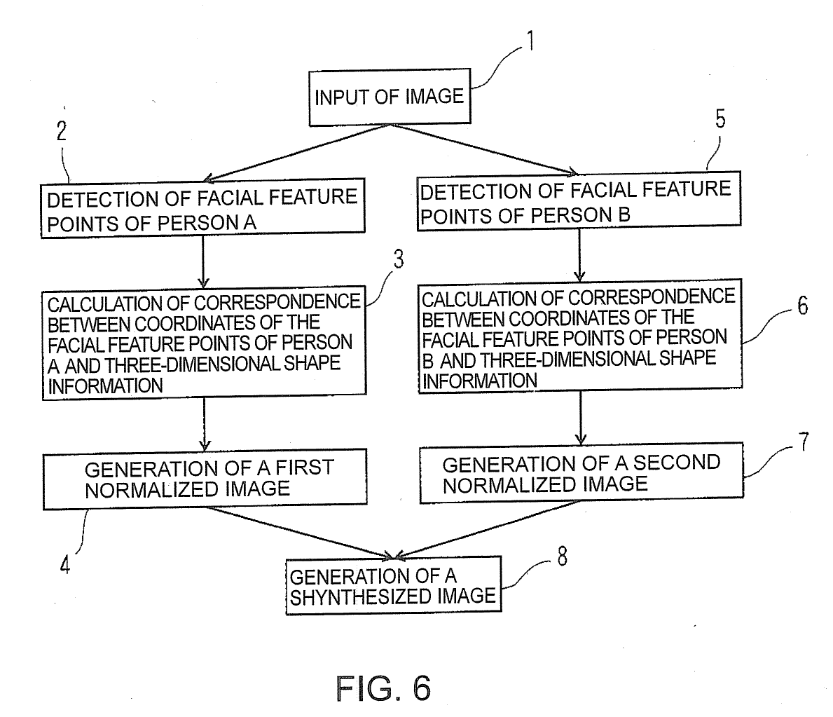

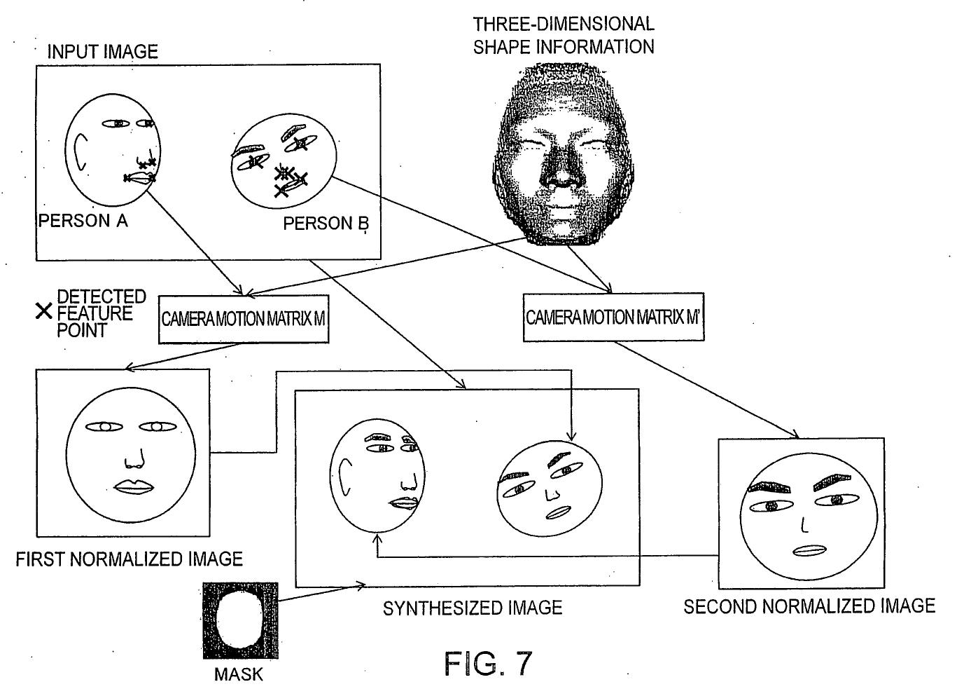

Operation of the image processing apparatus 10 of the second embodiment is explained by referring to FIGS. 6 and 7. FIG. 6 is a flow chart of operation of the image processing apparatus 10. FIG. 7 is a schematic diagram of situations of a series of operations.

First, the image input unit 12 inputs one image among dynamic images (step 1 in FIG. 6). Next, the feature point detection unit 14 detects facial feature points of two persons A and B from the image (steps 2 and 5 in FIG. 6). The method for detecting facial feature points is same as the first embodiment.

Next, the correspondence calculation unit 16 calculates a correspondence relationship between coordinates of facial feature points of the persons A and B (detected by the feature point detection unit 14) and coordinates of facial feature points of the three-dimensional shape information (steps 3 and 6 in FIG. 6). The method for calculating the correspondence relationship is same as the first embodiment.

Next, the normalized image generation unit 18 generates a first normalized image of the person A and a second normalized image of the person B (steps 4 and 7 in FIG. 6). The method for generating the normalized image is same as the first embodiment.

The synthesized image generation unit 20 synthesizes a region of the person A in the input image with a region of the person B in the second normalized image, and synthesizes a region of the person B in the input image with a region of the person A in the first normalized image (step 8 in FIG. 6). This processing of steps 1˜8 is repeated for each input image among dynamic images, and the synthesized image is displayed as a dynamic image.

As mentioned-above, with regard to the image processing apparatus 10 of the second embodiment, by mutually replacing faces of two persons in the input image, a synthesized image which two faces are blended in real time can be generated.

### The Third Embodiment

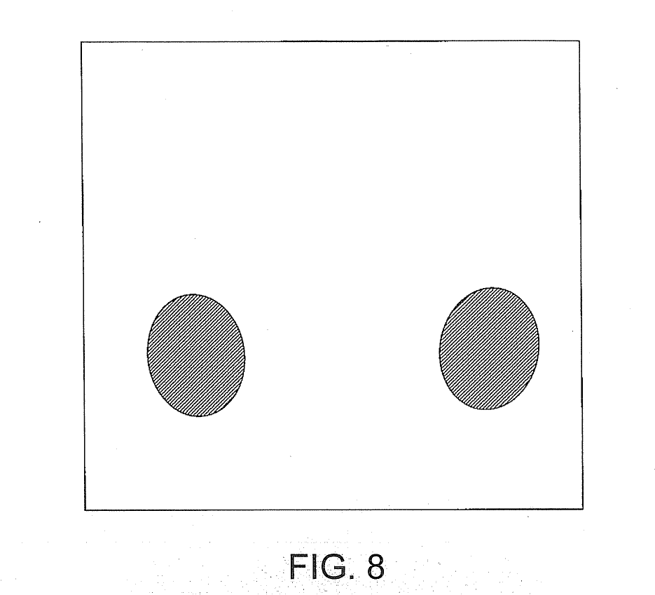

The image processing apparatus 10 of the third embodiment is explained by referring to FIGS. 1 and 8. With regard to the image processing apparatus 10 of the third embodiment, a synthesized image which a facial image is virtually made up is generated. Component of the image processing apparatus 10 of the third embodiment is same as the first embodiment.

In this case, the normalized image is prepared as a texture of make up status. For example, FIG. 8 is an exemplary texture of cheek blush. The image input, the feature point detection, and the correspondence calculation, are same as the first and second embodiments. Various make-up (rouge, eye shadow) are prepared as the normalized image. By combining these make-ups, a complicated image can be generated. In this way, with regard to the image processing apparatus 10 of the third embodiment, a synthesized image which a facial image is naturally made up is generated.

### The Fourth Embodiment

The image processing apparatus 10 of the fourth embodiment is explained. With regard to the image processing apparatus 10 of the fourth embodiment, a synthesized image which a facial image virtually wears an accessory (For example, glasses) is generated. The processing is almost same as the third embodiment.

In case of glasses, it is unnatural that the grasses are closely put on a face region on the synthesized image. Accordingly, as three-dimensional shape information except for the face model, a model of glasses is prepared. In case of generating a synthesized image, instead of correspondence relationship of the equation (1), Z-coordinate is replaced with a depth Zₘ of the accessory. As a result, a natural synthesized image which the glasses do not closely put on the face region is generated. In this way, with regard to the image processing apparatus 10 of the fourth embodiment, a synthesized image which the accessory (glasses) are naturally worn on the face image is generated.

(Modifications)

Hereafter, various modifications are explained. In above-mentioned embodiments, the normalized image generation unit 18 generates one normalized image from the second image. However, the normalized image generation unit 18 may generate a plurality of normalized image from the second image. In this case, the synthesized image generation unit 20 blends the plurality of normalized images at an arbitrary rate, and synthesizes the blended image with the first image.

In above-mentioned embodiments, the feature points are automatically detected. However, by preparing an interface to manually input feature points, the feature points may be input using the interface or previously determined. Furthermore, in above-mentioned embodiments, facial feature points are extracted from a person's face image. However, the person's face image is not always necessary, and an arbitrary image may be used. In this case, points corresponding to facial feature points of the person may be arbitrarily fixed.

In above-mentioned embodiments, a mask image is prepared on the normalized image corresponding to three-dimensional shape information. However, instead of the mask image set on the normalized image, by extracting a boundary of face region of person A from the image, αₘₐₛₖ may be determined based on the boundary.

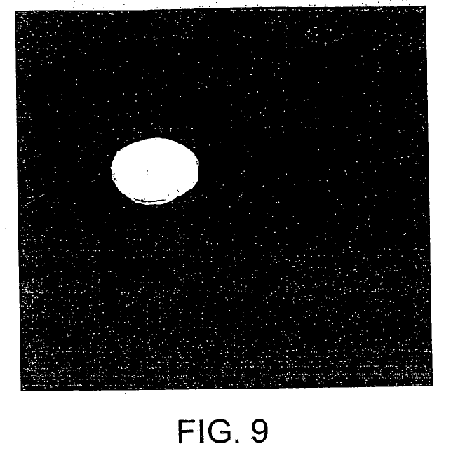

In above-mentioned embodiments, a face region is extracted as the mask image. However, as shown in FIG. 9, by using a mask corresponding to a partial region such as an eye, the partial region may be blended. Furthermore, by combining these masks, a montage image which partial regions of a plurality of persons are differently combined may be generated.

In above-mentioned embodiments, a face image of a person is processed. However, instead of the face image, a body image of the person or a vehicle image of an automobile may be processed.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for processing an image, comprising:
an image input unit configured to input a first image including an object;
a storage unit configured to store a three-dimensional shape information of a model for the object, the three-dimensional shape information including three-dimensional coordinates of a plurality of feature points of the model;
a feature point detection unit configured to detect a plurality of feature points from the first image;
a correspondence calculation unit configured to calculate a first motion matrix representing a correspondence relationship between the object and the model from the plurality of feature points of the first image and the plurality of feature points of the model;
a normalized image generation unit configured to generate a normalized image of a second image by corresponding the second image with the three-dimensional shape information; and
a synthesized image generation unit configured to correspond each pixel of the first image with each pixel of the normalized image by using the first motion matrix, and generate a synthesized image by blending a region of the object of the first image and corresponding pixels of the normalized image.

2. The apparatus according to claim 1, wherein
the synthesized image generation unit stores a mask image representing an arbitrary region of the normalized image, and synthesizes the first image with the arbitrary region of the normalized image by using mask image.

3. The apparatus according to claim 2, wherein
the arbitrary region is an inside region, an outside region, or a partial region of the object.

4. The apparatus according to claim 1, wherein
the normalized image generation unit generates a plurality of normalized images, and
the synthesized image generation unit blends the plurality of normalized images at an arbitrary rate, and synthesizes the first image with a blended image.

5. The apparatus according to claim 1, wherein
the object is a person's face, and
the normalized image includes a texture of a make-up or an accessory.

6. The apparatus according to claim 1, wherein
the image input unit inputs the second image,
the feature point detection unit detects a plurality of feature points from the second image,
the correspondence calculation unit calculates a second motion matrix representing a correspondence relationship between the second image and the model from the plurality of feature points of the second image and the plurality of feature points of the model; and
a normalized image generation unit generates the normalized image of the second image by using the second motion matrix.

7. A computer implemented method for causing a computer to process an image, comprising:
inputting a first image including an object;
storing a three-dimensional shape information of a model for the object, the three-dimensional shape information including three-dimensional coordinates of a plurality of feature points of the model;
detecting a plurality of feature points from the first image;
calculating a first motion matrix representing a correspondence relationship between the object and the model from the plurality of feature points of the first image and the plurality of feature points of the model;
generating a normalized image of a second image by corresponding the second image with the three-dimensional shape information; and
corresponding each pixel of the first image with each pixel of the normalized image by using the first motion matrix; and
generating a synthesized image by blending a region of the object of the first image with corresponding pixels of the normalized image.

8. A computer program stored in a computer readable medium for causing a computer to perform a method for processing an image, the method comprising:
inputting a first image including an object;
storing a three-dimensional shape information of a model for the object, the three-dimensional shape information including three-dimensional coordinates of a plurality of feature points of the model;
detecting a plurality of feature points from the first image;
calculating a first motion matrix representing a correspondence relationship between the object and the model from the plurality of feature points of the first image and the plurality of feature points of the model;
generating a normalized image of a second image by corresponding the second image with the three-dimensional shape information; and
corresponding each pixel of the first image with each pixel of the normalized image by using the first motion matrix; and generating a synthesized image by blending a region of the object of the first image with corresponding pixels of the normalized image.
